(19) United States
(12) Patent Application Publication
(10) Pub. No.: US 2026/0233233 A1
(43) Pub. Date: Aug. 13, 2026

(54) REPAIR APPARATUS AND REPAIR METHOD

(71) Applicants: JFE STEEL CORPORATION, Chiyoda-ku, Tokyo (JP); Yamamoto Rock Machine Co., Ltd., Chiyoda-ku, Tokyo (JP)

(72) Inventors: Yuji OHARA, Chiyoda-ku, Tokyo (JP); Shingo OKAMOTO, Chiyoda-ku, Tokyo (JP); Yuta HINO, Chiyoda-ku, Tokyo (JP); Takahiro KOSHIHARA, Chiyoda-ku, Tokyo (JP); Yoshiichi YATAGAI, Shobara-shi, Hiroshima (JP)

(73) Assignees: JFE STEEL CORPORATION, Chiyoda-ku, Tokyo (JP); Yamamoto Rock Machine Co., Ltd., Chiyoda-ku, Tokyo (JP)

(21) Appl. No.: 19/157,675

(22) PCT Filed: Mar. 18, 2024
(86) PCT No.: PCT/JP2024/010591

§ 371 Date: Aug. 18, 2025

(30) Foreign Application Priority Data
Mar. 24, 2023 (JP) 2023-048989

(51) Int. Cl. B02C 19/00

(52) U.S. Cl. CPC B02C 19/0056

(57) ABSTRACT

A repair apparatus for a container having an opening at an upper side and a refractory material layer on an inner surface includes a support frame spanning across the opening, a turning drive unit, a vertical support member extending in a vertical direction, a horizontal support member supported by the vertical support member in a liftable and lowerable manner and extending in a horizontal direction, a lifting drive unit configured to lift and lower the horizontal support member, a crushing device provided at one end of the horizontal support member and including a crushing tool at a tip thereof, and a reaction force support device provided at another end of the horizontal support member and including, at a tip thereof, an abutting member that abuts against the refractory material layer.

### TECHNICAL FIELD

The present disclosure relates to a repair apparatus for a container having a refractory material layer on its inner surface. The present disclosure also relates to a repair method for a container having a refractory material layer on its inner surface.

### BACKGROUND

For containers that hold high-temperature contents, it is common to provide a refractory material layer as a lining on the inner surface to protect the container body from the heat of the contents. Examples of containers with such a refractory material layer include containers for holding molten metal (hereinafter referred to as “molten metal containers”).

However, when using such containers, the refractory material layer gradually deteriorates because of wear caused by contact with high-temperature contents and because of spalling (cracking, peeling) due to thermal shock or the like. Therefore, it is necessary to perform regular repairs to maintain the function of the refractory material layer.

A common method for repairing the refractory material layer is to spray a monolithic refractory. However, if a monolithic refractory is sprayed onto a deteriorated refractory material layer, an interface between the deteriorated refractory material layer (hereinafter referred to as the deteriorated layer) and the new refractory material layer remains inside the repaired refractory material layer. Additionally, the surface of the deteriorated refractory material layer may have deposits known as buildup. This buildup mainly consists of metals and slag that adhered while the container was in use. Therefore, if cracks occur in the new refractory material layer on the surface side during the use of the container after repair, molten metal or the like may penetrate through the cracks to the interface between the deteriorated layer or buildup and the new refractory material layer, causing the new refractory material layer to peel off.

To prevent such peeling, when repairing the refractory material layer, the surface of the area to be repaired is chipped away to remove the deteriorated layer and the buildup adhered to the surface of the refractory material layer, after which the monolithic refractory is sprayed.

Methods for removing the deteriorated layer include using large heavy machinery such as hydraulic breakers. However, when such large heavy machinery is used, the shaped refractory (firebrick) that serves as the base for the monolithic refractory may be damaged.

Therefore, for example, Patent Literature (PTL) 1 proposes removing and dismantling the deteriorated layer over the entire surface of the refractory material layer using a repair apparatus provided with a crushing tool instead of the above-described heavy machinery when repairing by spraying the lining on the inner surface of a molten metal container.

### CITATION LIST

### Patent Literature

PTL 1: JP 2006-292278 A

### SUMMARY

### Technical Problem

According to the method proposed in PTL 1, by pressing the crushing tool with a constant force while removing the deteriorated layer, the deteriorated layer can be uniformly crushed.

However, in actual structures, the thickness of the buildup adhered to the surface of the refractory material layer and the thickness of the deteriorated layer are not necessarily uniform. In addition, there are cases in which the deteriorated refractory material layer is partially peeled off, resulting in the deteriorated layer becoming thinner in parts. Therefore, if the deteriorated layer is removed using the method described in PTL 1, non-deteriorated, sound refractory material is also removed, which results in an increase in the amount of monolithic refractory needed for repairs, resulting in wasteful repair costs. On the contrary, in areas where the deteriorated layer is thick, there are cases in which the deteriorated layer remains without being completely removed.

Therefore, to resolve the aforementioned problems, we conceived of precisely controlling the range (depth) of the removal of the refractory material layer with a crushing tool. For example, in the method proposed in PTL 2, the three-dimensional shape of the inner surface of the structure is measured, and the range for removing the refractory material layer is determined based on the obtained three-dimensional shape. According to such a method, it is possible to accurately remove the buildup and deteriorated layer attached to the surface of the refractory material layer while reducing the amount of the non-deteriorated refractory material layer that is removed.

However, upon further investigation, we discovered that even when combining the method proposed in PTL 2 with a conventional repair apparatus as described in PTL 1, it is difficult to control the range of removal of the refractory material layer accurately.

In light of the above, it is an aim of the present disclosure to control the range (depth) of removal of the refractory material layer accurately when removing the refractory material layer with a crushing device.

### Solution to Problem

As a result of examination, we discovered the following.
(1) A conventional repair apparatus as described in PTL 1 is equipped with crushing tools at both ends of a support member (hereinafter referred to as a horizontal support member) extending in the horizontal direction (FIGS. 4, 5, and 7 of PTL 1). In the case of such a structure, opposing surfaces inside the container are inevitably crushed simultaneously. However, in actual containers, the degradation conditions of the refractory material layer on the opposing surfaces are not necessarily the same, and the thickness of the adhered slag and the thickness of the deteriorated layer vary by position. Therefore, with a method that crushes the opposing surfaces simultaneously, it is difficult to appropriately control the range of removal of the refractory material layer according to the degradation conditions at each position.
(2) To solve the problem in (1), it is conceivable to use a device equipped with a crushing tool only at one end of the horizontal support member. According to such a device, since only one of the opposing surfaces on the inside of the container is crushed, it should be possible to appropriately control the range of removal of the refractory material layer according to the deterioration conditions.
(3) However, in a device equipped with a crushing tool only at one end of the horizontal support member, when the crushing tool is pressed against the refractory material for crushing, a force in the opposite direction due to reaction (hereinafter referred to as a reaction force) acts on the device. As a result, the device deforms, causing the position of the crushing tool to shift and making it difficult to control the range of removal of the refractory material layer appropriately.
(4) Therefore, by providing a reaction force support device for supporting against the reaction force at the other end of the horizontal support member, it is possible to prevent deformation of the device due to the reaction force and to prevent the resulting misalignment of the crushing tool. As a result, it becomes possible to control the range of removal of the refractory material layer with extreme accuracy.

The present disclosure is based on the above findings, and the main features thereof are as follows.
1. A repair apparatus for a container having an opening at an upper side and a refractory material layer on an inner surface, the repair apparatus comprising:
a support frame spanning across the opening;
a turning drive unit provided at a lower portion of the support frame;
a vertical support member provided at a lower portion of the turning drive unit and extending in a vertical direction;
a horizontal support member supported by the vertical support member in a liftable and lowerable manner and extending in a horizontal direction;
a lifting drive unit configured to lift and lower the horizontal support member;
a crushing device provided at one end of the horizontal support member and including a crushing tool at a tip thereof; and
a reaction force support device provided at another end of the horizontal support member and including, at a tip thereof, an abutting member that abuts against the refractory material layer.
2. The repair apparatus according to 1, wherein the crushing device comprises a first actuator,
the crushing tool is configured to be movable by the first actuator back and forth in a direction parallel to the horizontal support member,
the reaction force support device comprises a second actuator, and
the abutting member is configured to be movable by the second actuator back and forth in the direction parallel to the horizontal support member.
3. The repair apparatus according to 2, wherein the first actuator and the second actuator are hydraulic cylinders of identical specifications connected to a same hydraulic source and are configured to operate synchronously in opposite directions.
4. The repair apparatus according to any one of 1 to 3, wherein the abutting member is made of a soft material.
5. The repair apparatus according to 2 or 3, wherein the abutting member is supported by the second actuator to be swingable in at least one direction.
6. A repair method for using a repair apparatus to repair a container having an opening at an upper side and a refractory material layer on an inner surface,
the repair apparatus comprising:
   a horizontal support member extending in a horizontal direction;
   a crushing device provided at one end of the horizontal support member; and
   a reaction force support device provided at another end of the horizontal support member,
the repair method comprising:
   driving the horizontal support member continuously or intermittently in one or both of a rotational direction and a vertical direction;
   pressing the crushing device against one surface of opposing inner surfaces of the container;
   pressing the reaction force support device against another surface of the opposing inner surfaces; and
   crushing, using the crushing device, at least a surface layer of a refractory material layer on the one surface.

A repair method in another embodiment of the present disclosure can be as follows.

A method of repairing a container having an opening at an upper side and a refractory material layer on an inner surface, the method comprising:
installing the repair apparatus according to any one of 1 to 5 at the opening of the container;
while continuously or intermittently driving the horizontal support member in a rotational direction and a vertical direction with the turning drive unit and the lifting drive unit,
pressing the crushing device against one surface of opposing inner surfaces of the container and pressing the reaction force support device against another surface of the opposing inner surfaces; and
crushing, using the crushing device, at least a surface layer of a refractory material layer on the one surface.

### Advantageous Effect

It is possible to prevent deformation of the apparatus due to the reaction force when the crushing tool is pressed, and to prevent the resulting misalignment of the crushing tool. As a result, it becomes possible to control the range of removal of the refractory material layer with extreme accuracy.

### BRIEF DESCRIPTION OF THE DRAWINGS

In the accompanying drawings:

FIG. 1 is a cross-sectional schematic diagram illustrating an example of the structure of a container;

FIG. 2 is a schematic diagram illustrating the structure of a repair apparatus in an embodiment of the present disclosure; and

FIGS. 3A and 3B are schematic diagrams illustrating examples of a support structure of an abutting member.

### DETAILED DESCRIPTION

The present disclosure is described below in detail. Note that the present disclosure is not limited to this embodiment. In addition, elements not mentioned in the present specification can be similar to those of conventional repair apparatuses and repair methods.

The repair apparatus in one embodiment of the present disclosure is a repair apparatus for a container having an opening at the upper side and a refractory material layer on an inner surface, and the repair apparatus includes the following elements.
a support frame spanning across the opening
a turning drive unit provided at a lower portion of the support frame
a vertical support member provided at a lower portion of the turning drive unit and extending in a vertical direction
a horizontal support member supported by the vertical support member in a liftable and lowerable manner and extending in a horizontal direction
a lifting drive unit configured to lift and lower the horizontal support member
a crushing device provided at one end of the horizontal support member
a reaction force support device provided at another end of the horizontal support member

By providing the reaction force support device, it is possible to support against the reaction force generated at the time of crushing using the crushing device, thereby preventing deformation of the apparatus and the resulting misalignment of the crushing tool. As a result, it becomes possible to control the range of removal of the refractory material layer with extreme accuracy.

Next, with reference to the drawings, the present disclosure will be described in more detail. Examples of preferred embodiments of the present disclosure are described below, but the present disclosure is not limited to the embodiments described below.

### [Container]

The present disclosure is for repairing a container that has a refractory material layer on the inner surface thereof. The container may be any container that has an opening at the upper side and a refractory material layer at least on the inner surface thereof. The container may, for example, be a container for molten metal. Examples of the container for molten metal include a transfer ladle, a molten steel ladle, and a refining vessel.

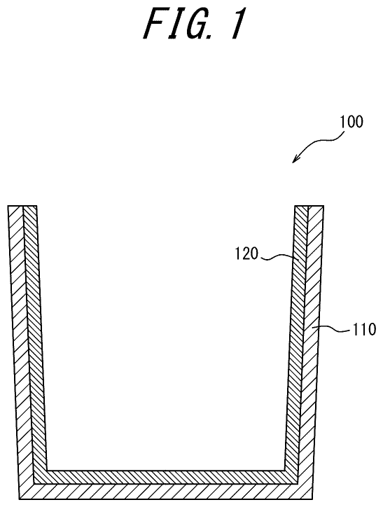

FIG. 1 is a cross-sectional schematic diagram illustrating an example of the structure of the container. The container 100 includes a metal container body 110 and a refractory material layer 120 provided on the inner surface of the container body 110. The container body 110 is typically made of steel and is also referred to as an iron skin. The refractory material layer 120 is also referred to as a lining.

The present disclosure can be applied to any refractory material layer having any material properties and structure. Therefore, the refractory material layer 120 may have any material properties and structure as long as it is made of refractory material.

It is also common for the refractory material layer serving as a lining to be configured by a shaped refractory layer provided on the surface of the container body and a monolithic refractory layer provided on the surface of the shaped refractory layer. In the case of repairing a refractory material layer consisting of a shaped refractory layer and a monolithic refractory layer, it is common to crush and remove at least a part of the monolithic refractory layer located on the surface side, while reusing, rather than removing, the shaped refractory layer. The present disclosure can also be suitably used for the repair of a refractory material layer having such a structure.

The shape of the container is not particularly limited, but the container may typically have a circular horizontal cross-section. In the case of the horizontal cross-section of the container being circular, the container may have a constant inner diameter, i.e., the container may be cylindrical. Additionally, the container may be shaped so that the inner diameter decreases with increased distance from the opening (farther downward), like the container 100 illustrated in FIG. 1.

### [Repair Apparatus]

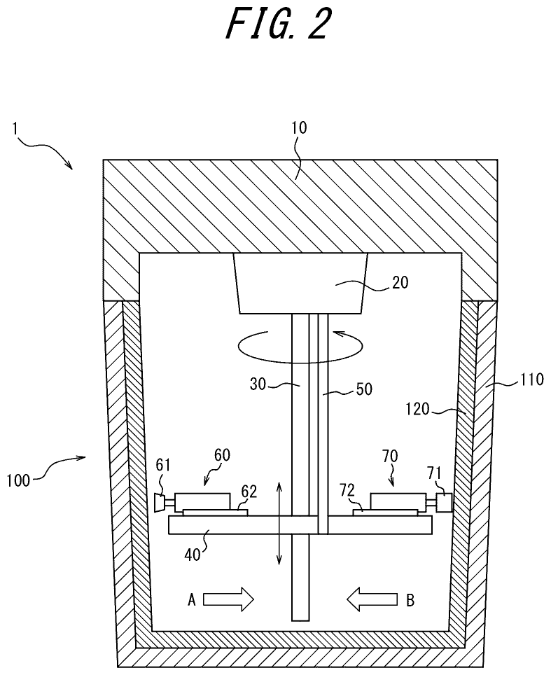

FIG. 2 is a schematic diagram illustrating the structure of a repair apparatus 1 in an embodiment of the present disclosure. The repair apparatus 1 includes a support frame 10, and the repair apparatus 1 is installed at the upper portion of the container 100 by the support frame 10 spanning across the opening of the container 100.

The method of installing the support frame 10 is not particularly limited, and the support frame 10 can be installed at the upper portion of the container 100 by any method. For example, as illustrated in FIG. 2, the support frame 10 may be placed on the upper end of the container 100.

However, the upper end of the container is susceptible to deformation due to the heat and weight of the contents (for example, molten steel). In addition, the contents may adhere to the upper end when being loaded and unloaded, resulting in the upper end not being flat. Therefore, from the perspective of stably supporting the repair apparatus, the support frame 10 is preferably placed on a portion other than the upper end surface of the container.

For example, in a case in which the container 100 is a container that is transported and used, the container 100 may have a plurality of protrusions (trunnions), on the outer peripheral surface of the container, used by a crane or the like for hanging. In that case, the support frame 10 may be installed by engagement with the protrusions.

In containers such as ladles, an annular reinforcing member referred to as a stiffener may be provided on the outer periphery of the container to enhance the rigidity of the container. Since such a stiffener is usually provided at a position lower than the upper surface of the container and protrudes outward, the stiffener is generally less susceptible to deformation due to the contents, and the contents do not adhere to the stiffener. Therefore, placement of the support frame 10 on the upper end surface of such a stiffener is also preferable.

Furthermore, from the perspective of installing the repair apparatus horizontally and stably, the support frame preferably includes a plurality of support legs that are independently adjustable in height. By installation of the support frame on the container via the support legs, the height and tilt of the entire repair apparatus can be finely adjusted, thereby further improving the repair accuracy. The number of support legs is not particularly limited and may be any number, 2 or more. The number is preferably 3 or more. The number is more preferably 3 to 5. The number is even more preferably 4. The support legs preferably include hydraulic actuators for height adjustment.

In addition, since the repair apparatus usually has a certain weight, it is fixed to a certain extent by its own weight. However, if the reaction force during crushing is large, the repair apparatus may shift. To avoid this, the support frame 10 may be engaged with trunnions, as described above, or the support frame 10 may be secured to the container 100 using fasteners such as pins or bolts. Therefore, it is also preferable for the support frame 10 and the container 100 to have fixing holes through which pins or bolts are passed to secure the support frame 10.

A turning drive unit 20 is provided at the lower portion of the support frame 10, and a vertical support member 30 is provided at the lower portion of the turning drive unit 20. The vertical support member 30 is a member that extends in the vertical direction (up/down direction in FIG. 2) and is rotatably supported by the turning drive unit 20.

A horizontal support member 40 that extends in the horizontal direction is supported by the vertical support member 30 in a liftable and lowerable manner, and the horizontal support member 40 is driven in the up/down direction (longitudinal direction of the vertical support member 30) by a lifting drive unit 50.

### (Crushing Device)

At one end of the horizontal support member 40, a crushing device 60 that includes a crushing tool 61 at the tip thereof is provided. By driving the crushing tool 61 while it is pressed against the surface of the refractory material layer 120, it is possible to remove the deteriorated layer, buildup, and the like present on the surface of the refractory material layer 120. The crushing tool is also referred to as a bit.

Any device that can crush and remove the refractory material layer can be used as the crushing device 60. Typically, a crushing device that crushes the refractory material layer 120 by applying either or both rotational force and impact force to the crushing tool 61 while the crushing tool 61 is in contact with the refractory material layer is used. The impact force may be applied via a reciprocating motion that moves the crushing tool 61 back and forth against the surface of the refractory material layer 120. A hydraulic drifter, for example, can be suitably used as the crushing tool 61.

### (Reaction Force Support Device)

A reaction force support device 70 is provided at the other end of the horizontal support member 40, and an abutting member 71 that abuts against the refractory material layer 120 is provided at the tip of the reaction force support device 70. When the refractory material layer 120 is crushed with the crushing device 60, the abutting member 71 is abutted against the surface of the refractory material layer 120 on the side opposite side from the surface being crushed, thereby suppressing deformation of the repair apparatus 1 due to the reaction force and enabling precise control of the position of the crushing tool 61.

In particular, in the repair apparatus of the present embodiment, the crushing device 60 is supported by the vertical support member 30 via the horizontal support member 40. Therefore, in a case in which the reaction force support device 70 is not provided, a bending moment acts on the vertical support member 30 in the direction indicated by the arrow A, with the point of connection to the turning drive unit 20 as the fulcrum. Therefore, by applying a force in the opposite direction (arrow B) with the reaction force support device 70, the bending moment can be canceled out.

The abutting member 71 is not particularly limited, and any member may be used. A preferred embodiment of the abutting member will be described later.

### (Actuator)

The repair apparatus preferably includes actuators for adjusting the positions of the crushing tool and the abutting member. A preferred embodiment for the case of using actuators is described below.

The crushing device 60 preferably includes a first actuator 62 for adjusting the position of the crushing tool 61. In this case, the crushing tool 61 is configured to be movable by the first actuator 62 back and forth in a direction parallel to the horizontal support member 40. By use of the first actuator 62, the crushing tool 61 can be moved horizontally to crush the refractory material layer to a desired depth.

Similarly, the reaction force support device 70 preferably includes a second actuator 72 for adjusting the position of the abutting member 71. In this case, the abutting member 71 is configured to be movable by the second actuator 72 back and forth in the direction parallel to the horizontal support member 40. By use of the second actuator 72, the abutting member 71 can be moved horizontally and pressed against the refractory material layer with a desired strength. During crushing, it suffices to control the second actuator to press the abutting member 71 against the refractory material layer so as to cancel the reaction force generated by the pressing of the crushing tool 61 against the refractory material layer.

Any actuators that can drive the crushing device and the reaction force support device can be used as the first and second actuators, but a hydraulic cylinder is preferably used. A type of hydraulic cylinder that is equipped with a stroke measurement sensor is preferably used as the hydraulic cylinder.

In the case of using hydraulic cylinders as the first and second actuators, hydraulic cylinders with identical specifications are preferably used. The hydraulic cylinders with identical specifications are preferably connected to the same hydraulic source and configured to operate synchronously in opposite directions. Adopting such a structure makes it possible, with a simple structure, to press the reaction force support device against the refractory material layer with a force that balances the reaction force generated by pressing the crushing device against the refractory material layer, thereby offsetting the reaction force.

### (Abutting Member)

Next, a preferred embodiment of the abutting member provided in the reaction force support device is described.

### Material Properties

As mentioned above, the abutting member is not particularly limited, and any member may be used. However, if the abutting member is hard, there is a risk of damaging the surface (support surface) of the refractory material layer against which the abutting member abuts. Therefore, from the perspective of reducing the risk of damage to the refractory material layer, the abutting member is preferably made of a soft material and is more preferably made of an elastic material. A material selected from resins and rubbers, for example, is preferably used as the soft material. A combination of a plurality of soft materials can also be used. Rubber, for example, is preferably used as the elastic material. The rubber referred to here includes elastomers.

### Shape

The shape of the abutting member is not particularly limited, and the abutting member can have any shape. In one embodiment of the present disclosure, the abutting member is preferably flat on the surface (abutment surface) that abuts against the refractory material layer. By the abutment surface being flat, it is possible to reliably support against the reaction force while preventing the concentration of force on a single point of the refractory material layer. A block-shaped or sheet-shaped abutting member, for example, can be used as an abutting member with a flat abutment surface.

The shape of the abutment surface is not particularly limited but typically can be rectangular or circular.

In another embodiment of the present disclosure, a wheel can be used as the abutting member. As mentioned earlier, the surface of the refractory material layer has irregularities formed by the adhesion of molten metal, slag, and the like, or by the peeling of part of the refractory material layer. However, if the abutting member is a wheel, the abutting member can be smoothly moved while abutted against the surface of the refractory material layer. The wheel is preferably free to rotate. The rotating surface of the wheel is preferably free to rotate with the longitudinal direction of the horizontal support member as the rotation axis. By having such a structure, the wheel as an abutting member can be smoothly moved in any direction while abutted against the refractory material layer.

### Support Method

As already explained, the abutting member is preferably movable by the second actuator back and forth in a direction parallel to the horizontal support member. In this case, the abutting member can be attached to the second actuator by any method, but the abutting member is preferably supported by the second actuator to be swingable in at least one direction. By configuring the abutting member to be swingable, the reaction force can be supported stably even if the surface of the refractory material layer is inclined or irregular.

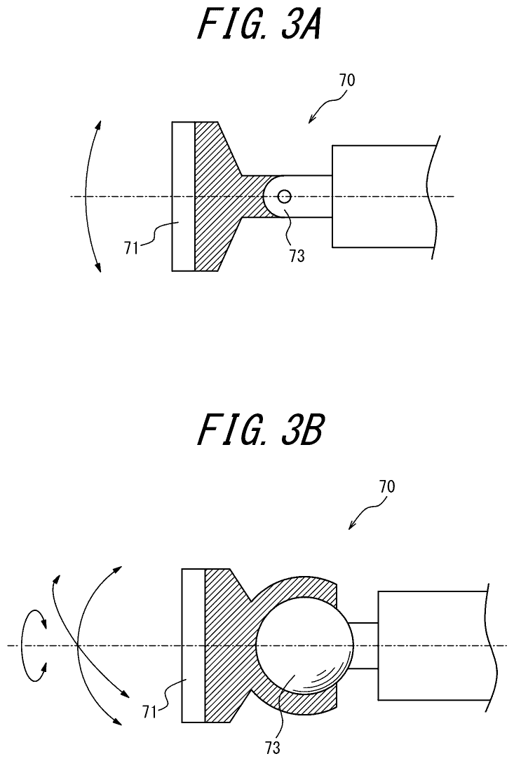

FIG. 3A is a schematic diagram illustrating an example of the structure in the case of supporting the abutting member 71 to be swingable in one direction. In this example, the abutting member 71 is supported using a joint 73 with one degree of freedom of rotation, and the abutting member 71 can swing freely in one axial direction as indicated by the arrow. In FIG. 3A, the case of swinging in the up/down direction is illustrated, but the swinging direction is not particularly limited and may be in any direction, such as horizontal. The abutting member 71 is more preferably swingable in two directions. An example of a method for enabling swinging in two directions is to use two joints, with one degree of freedom each, that have different swinging directions.

FIG. 3B is a schematic diagram illustrating an example of a structure when a ball joint is used as a joint 73 supporting the abutting member 71. In this example, the ball joint is used to provide support in three axial directions. That is, as indicated by the arrows in the figure, the abutting member 71 can swing in any direction, including the up/down and left/right directions, and can also rotate with the central axis of the ball joint as the rotation axis.

### [Repair Method]

A repair method in one embodiment of the present disclosure is as follows.

A repair method for using a repair apparatus to repair a container having an opening at an upper side and a refractory material layer on an inner surface,
the repair apparatus comprising:
   a horizontal support member extending in a horizontal direction;
   a crushing device provided at one end of the horizontal support member; and
   a reaction force support device provided at another end of the horizontal support member,
the repair method comprising:
   driving the horizontal support member continuously or intermittently in one or both of a rotational direction and a vertical direction;
   pressing the crushing device against one surface of opposing inner surfaces of the container;
   pressing the reaction force support device against another surface of the opposing inner surfaces; and
   crushing, using the crushing device, at least a surface layer of a refractory material layer on the one surface.

When crushing the refractory material layer with the crushing device, the reaction force support device is pressed against the surface of the refractory material layer on the side opposite from the surface being crushed, thereby suppressing deformation of the repair apparatus due to the reaction force and enabling precise control of the position to be crushed.

An example of a preferred embodiment of the above repair method is described below. In the embodiment illustrated below, a repair apparatus provided with the above-described support frame, turning drive unit, and vertical support member is used, but the repair apparatus used in the repair method of the present disclosure is not limited to this example.

When performing repairs on the container using the aforementioned repair apparatus, first, as illustrated in FIG. 2, the repair apparatus 1 is installed at the opening of the container 100. Then, while the horizontal support member 40 is continuously or intermittently driven in the rotational direction and vertical direction by the turning drive unit 20 and the lifting drive unit 50, the crushing device 60 crushes at least the surface of the refractory material layer 120. At this time, by pressing the crushing device 60 against one surface of opposing inner surfaces of the container 100 and pressing the reaction force support device 70 against the other surface of the opposing inner surfaces, the reaction force is canceled out.

The specific driving method of the crushing device is not limited. For example, while the crushing device is pressed against the refractory material layer to perform crushing, the horizontal support member may be driven using one or both of the turning drive unit and the lifting drive unit to move the crushing device in one or both of the inner circumferential direction (rotational direction) and height direction of the container. According to this method, the refractory material layer can be continuously crushed.

However, as mentioned earlier, in actual containers, the degradation conditions of the refractory material layer on the opposing surfaces are not necessarily the same, and the thickness of the adhered slag and the thickness of the deteriorated layer vary by position. Therefore, to remove the deteriorated layer reliably while preventing the removal of non-deteriorated, sound refractory material, the depth of crushing of the refractory material layer is preferably adjusted for each position on the inner surface of the container. From the above perspective, the refractory material on the inner circumference of the container is preferably crushed by repeating the processes (1) to (3) below.
(1) While the horizontal support member is in a stopped state, move the crushing device forward towards the refractory material layer to crush the refractory material layer.
(2) After crushing the refractory material layer to the desired depth, retract the crushing device to a position where the crushing tool does not come into contact with the refractory material layer.
(3) Using one or both of the turning drive unit and the lifting drive unit, drive the horizontal support member and move the crushing device in one or both of the inner circumferential direction (rotational direction) and height direction of the container at a predetermined pitch.

Regardless of the method used for crushing, it suffices to drive the reaction force support device in conjunction with the forward and backward movement of the crushing device to cancel out the reaction force.

### (Control of Crushing Depth)

As described above, to remove the deteriorated layer reliably while preventing the removal of non-deteriorated, sound refractory material, the depth of crushing of the refractory material layer is preferably adjusted for each position on the inner surface of the container. Therefore, in one embodiment of the present disclosure, the repair apparatus preferably includes a control unit that controls the crushing device based on data on a predetermined target crushing depth for each position on the inner surface of the container. In a repair method of one embodiment of the present disclosure, the crushing device is preferably controlled by the control unit to crush the refractory material layer to the predetermined target crushing depth for each position on the inner surface of the container.

The aforementioned target crushing depth is not particularly limited and can be determined by any method. For example, the target crushing depth can be determined based on the usage history of the container to be repaired and the condition of the refractory material layer on the inner surface of the container at the time of repair.

As information regarding the usage history of the container, use of data obtained by periodically measuring the three-dimensional shape of the inner surface of the container is particularly preferable. For example, from the measurement data, it is possible to determine the occurrence of peeling of the refractory material layer at each part of the inner surface of the container and to identify the areas of peeling. If no peeling occurs, it is also possible to estimate the approximate thickness of the formed deteriorated layer from the usage history of the container (number of uses, duration of use, and the like). Therefore, in determining the target crushing depth, it is also possible to use the estimated thickness of the deteriorated layer estimated from the usage history of the container. Moreover, the thickness of the deteriorated layer that is formed tends to saturate at a certain level (for example, around 30 mm to 40 mm). Therefore, the known saturation thickness of the deteriorated layer can also be used in determining the target crushing depth.

The three-dimensional shape of the inner surface of the container at the time of repair can be measured and used in determining the target crushing depth.

### (Control Considering Deformation of Apparatus)

As described above, by using the reaction force support device to cancel out the reaction force, it is possible to offset the bending moment applied to the repair apparatus, particularly the vertical support member, and accurately control the crushing depth.

However, from the perspective of further improving the accuracy of the crushing depth, the target crushing depth is preferably corrected taking into consideration the rigidity of the repair apparatus. An example of such a method is described below.

When repairing the refractory material layer with the repair apparatus of the present disclosure, crushing is performed while pressing the crushing device against the inner surface of the container. To crush the refractory material layer, however, it is necessary to press the tool with considerable strength. Then, to balance the reaction force, the surface opposite the surface pressed by the crushing device is pressed by the reaction force support device. Therefore, a strong compaction force acts on the horizontal support member where the repair apparatus, particularly the crushing device, is installed, directed from both ends toward the center, resulting in elastic deformation corresponding to the rigidity (spring constant) of the member.

At this time, the amount of deformation x due to the elastic deformation can be expressed by Expression (1) below according to Hooke's law.

$$x = F / k \qquad ( 1 )$$

The definitions of the symbols are as follows.
x: amount of deformation (mm)
F: force applied to device (N)
k: spring constant (N/mm)

Therefore, even if the actuator (hydraulic cylinder) is driven to push the device in by a stroke δ_{d} (mm) in the depth direction from the surface of the refractory material layer, the actual crushing depth 6 will decrease by the amount of deformation of the device. Specifically, the actual crushing depth δ is expressed by Expression (2) below.

$$δ = {δ}_{d} - F / k \qquad ( 2 )$$

The definitions of the symbols are as follows.
δd: total amount of stroke of the hydraulic cylinder (mm)
F: force applied to device (N)
k: spring constant (N/mm)

For the stroke of the hydraulic cylinder, the point at which the crushing tool or abutting member first comes into contact with the surface of the refractory material layer is taken as the initiation point (0 mm). The aforementioned spring constant is the spring constant of the entire system including the crushing device, the first actuator, the reaction force support device, the second actuator, the horizontal support member, and the like.

Therefore, when crushing the refractory material layer using the above repair apparatus, control is preferably performed so that the actual crushing depth 6 becomes the target crushing depth using Expression (2) above. This approach can compensate for the amount of deformation of the device and can control the removal depth of the refractory material layer with even higher accuracy.

The aforementioned spring constant k can be experimentally determined by measuring the relationship between the force F applied to the device and the amount of deformation x in advance.

The force F applied to the device can be measured in real-time by a pressure sensor attached to the hydraulic cylinder. That is, since the pressure receiving area of the hydraulic cylinder is known, the force F can be calculated by multiplying the pressure measured by the pressure sensor by the pressure receiving area.

### REFERENCE SIGNS LIST

| | |
|---|---|
| 1 | Sample for frictional coefficient measurement |
| 10 | Support frame |
| 20 | Turning drive unit |
| 30 | Vertical support member |
| 40 | Horizontal support member |
| 50 | Lifting drive unit |
| 60 | Crushing device |
| 61 | Crushing tool |
| 62 | First actuator |
| 70 | Reaction force support device |
| 71 | Abutting member |
| 72 | Second actuator |
| 73 | Joint |
| 100 | Container |
| 110 | Container main body |
| 120 | Refractory material layer |

1. A repair apparatus for a container having an opening at an upper side and a refractory material layer on an inner surface, the repair apparatus comprising:
a support frame spanning across the opening;
a turning drive unit provided at a lower portion of the support frame;
a vertical support member provided at a lower portion of the turning drive unit and extending in a vertical direction;
a horizontal support member supported by the vertical support member in a liftable and lowerable manner and extending in a horizontal direction;
a lifting drive unit configured to lift and lower the horizontal support member;
a crushing device provided at one end of the horizontal support member and including a crushing tool at a tip thereof; and
a reaction force support device provided at another end of the horizontal support member and including, at a tip thereof, an abutting member that abuts against the refractory material layer.

2. The repair apparatus according to claim 1, wherein
the crushing device comprises a first actuator,
the crushing tool is configured to be movable by the first actuator back and forth in a direction parallel to the horizontal support member,
the reaction force support device comprises a second actuator, and
the abutting member is configured to be movable by the second actuator back and forth in the direction parallel to the horizontal support member.

3. The repair apparatus according to claim 2, wherein the first actuator and the second actuator are hydraulic cylinders of identical specifications connected to a same hydraulic source and are configured to operate synchronously in opposite directions.

4. The repair apparatus according to claim 1, wherein the abutting member is made of a soft material.

5. The repair apparatus according to claim 2, wherein the abutting member is supported by the second actuator to be swingable in at least one direction.

6. A repair method for using a repair apparatus to repair a container having an opening at an upper side and a refractory material layer on an inner surface,
the repair apparatus comprising:
a horizontal support member extending in a horizontal direction;
a crushing device provided at one end of the horizontal support member; and
a reaction force support device provided at another end of the horizontal support member,
the repair method comprising:
driving the horizontal support member continuously or intermittently in one or both of a rotational direction and a vertical direction;
pressing the crushing device against one surface of opposing inner surfaces of the container;
pressing the reaction force support device against another surface of the opposing inner surfaces; and
crushing, using the crushing device, at least a surface layer of a refractory material layer on the one surface.

7. The repair apparatus according to claim 2, wherein the abutting member is made of a soft material.

8. The repair apparatus according to claim 3, wherein the abutting member is supported by the second actuator to be swingable in at least one direction.
